(19) United States
(12) Patent Application Publication
(10) Pub. No.: US 2013/0113256 A1
(43) Pub. Date: May 9, 2013

(54) Seat Leveler

(71) Applicant: Alvin Allen, Bracebridge (CA)

(72) Inventor: Alvin Allen, Bracebridge (CA)

(21) Appl. No.: 13/663,533

(22) Filed: Oct. 30, 2012

Related U.S. Application Data
(60) Provisional application No. 61/555,596, filed on Nov. 4, 2011.

(51) Int. Cl. B60N 2/10; B60N 2/38

(52) U.S. Cl. 297/344.1

(57) ABSTRACT

A seat leveling device is disclosed for stabilizing the seat of a vehicle when moving over uneven terrain. The seat leveling device comprises a vehicle and a seat secured to the vehicle. The vehicle is typically a hillside lift used to carry passengers and goods back and forth between a hilltop and a bottom of the hill. The seat leveling device further comprises a detection component and a drive component, wherein the detection component is in communication with the drive component. Specifically, the detection component detects a position of the seat and transmits a signal to the drive component when the seat becomes unleveled. In one embodiment, the detection component is a pendulum and the drive component is a hydraulic pump and cylinder. The pendulum is secured to the seat, and swings when the seat becomes unleveled, which activates the hydraulic pump and cylinder to level the seat.

### CROSS-REFERENCE

This application claims priority from Provisional Patent Application Ser. No. 61/555,596 filed Nov. 4, 2011.

### BACKGROUND

The construction of hillside lifts requires the vehicle to follow a relatively straight line and remain in relatively the same plane during the trip, because there currently is no way to change the orientation of the vehicle itself. If the track were to follow the contour of the land, an unexpected pitch of the seat, resulting from the simple movement of cresting a hill, could dislodge riders, risking severe injury or death if riders were to fall out of the vehicle. Because of this, hillside lift designers must build their track in a relatively straight line. Oftentimes natural hillside formations are not conducive to this type of linear design, and require expensive hill and rock removal to fit in the track. In other situations, the straight track must cross dangerously high expanses of valley and rock, making construction and maintenance of the lift both expensive and hazardous. Hillside lift designers and users would benefit from a device that allows lift tracks to follow natural land formations without risk to riders and cargo.

There is a need for an improved seat leveler device that can work on any hillside lift to stabilize the vehicle when moving over uneven terrain, protecting passenger and cargo from dangerous degree pitches. The present invention provides a seat leveling device for stabilizing the seat of a vehicle when moving over uneven terrain, and allows the designers of hillside lifts to build around the contour of the land, preventing the need for expensive hill or rock removal. The seat leveler device would also eliminate the need to cross dangerously high expanses of rock and valley because hillside lifts that use this device would not have to follow a straight path.

Hillside lifts are commonly used to carry passengers and goods from buildings on a hilltop to the boathouse or dock on the lake at the bottom of the hill, and anyone who is looking for a safer, more efficient method of installing a hillside lift would benefit from this device. This device would also be beneficial to the mining industry, which frequently requires access to dangerously steep locations. The seat leveler device can maintain a safe and horizontal position the entire trip despite changes in plane.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a seat leveling device for stabilizing the seat of a vehicle when moving over uneven terrain. The seat leveling device comprises a vehicle and a seat secured to the vehicle. The vehicle is typically a hillside lift vehicle used to carry passengers and goods back and forth between a hilltop and a bottom of the hill, but can be any suitable vehicle as is known in the art. The seat leveling device further comprises a detection component and a drive component, wherein the detection component is in communication with the drive component. Specifically, the detection component detects a position of the seat and transmits a signal to the drive component when the seat becomes unleveled. In one embodiment, the detection component is a pendulum and the drive component is a hydraulic pump and cylinder. The pendulum is secured to the seat, and swings when the seat becomes unleveled, which activates the hydraulic pump and cylinder to level the seat (i.e., raise or lower the seat).

In another embodiment, the detection component is a pair of opposing mercury leveling switches and the drive component is a linear actuator. The leveling switches are secured to the seat, and as the seat becomes unleveled or changes planar angles the mercury within the leveling switches would shift to activate the linear actuator to level the seat (i.e., raise or lower the seat).

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of the seat leveling device in accordance with the disclosed architecture.

FIG. 2 illustrates a perspective view of the detection component of the seat leveling device in accordance with the disclosed architecture.

FIG. 3 illustrates a perspective view of the detection component of the seat leveling device in accordance with the disclosed architecture.

FIG. 4 illustrates a perspective view of the detection component of the seat leveling device in accordance with the disclosed architecture.

FIG. 5 illustrates a perspective view of the drive component of the seat leveling device in accordance with the disclosed architecture.

FIG. 6 illustrates a perspective view of the drive component of the seat leveling device in accordance with the disclosed architecture.

FIG. 7 illustrates a perspective view of the drive component of the seat leveling device in accordance with the disclosed architecture.

FIG. 8 illustrates a perspective view of the seat leveling device in use in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses a seat leveler device that can work on any hillside lift or other suitable vehicle to stabilize the seat of the vehicle when moving over uneven terrain, thus protecting passengers and cargo from dangerous degree pitches. The present invention allows the designers of hillside lifts to build around the contour of the land, preventing the need for expensive hill or rock removal. This invention maintains a safe and horizontal seat position the entire trip despite changes in plane.

The seat leveling device comprises a vehicle and a seat secured to the vehicle. The vehicle is typically a hillside lift used to carry passengers and goods back and forth between a hilltop and a bottom of the hill, or any other suitable vehicle. The seat leveling device further comprises a detection component and a drive component, wherein the detection component is in communication with the drive component. Specifically, the detection component detects a position of the seat and transmits a signal to the drive component when the seat becomes unleveled. The drive component then levels the seat (i.e., raises or lowers the seat).

Thus, passengers and cargo are protected from dangerous degree pitches when moving over uneven terrain. Anyone who is looking for a safer, more efficient method of installing a hillside lift would benefit from this device. This device would also be beneficial to the mining industry, which frequently requires access to dangerously steep locations.

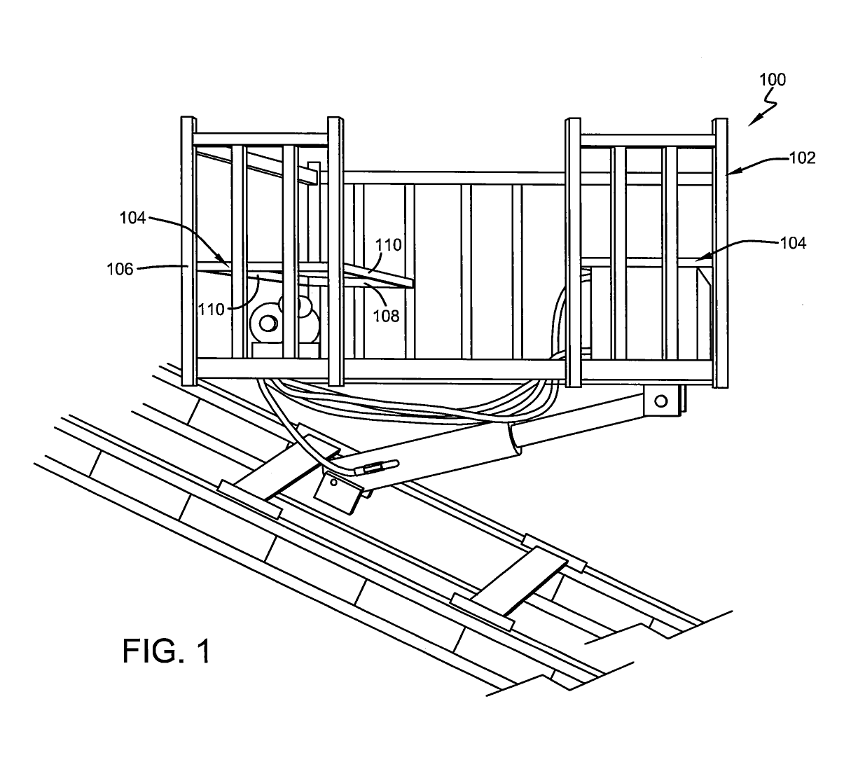

Referring initially to the drawings, FIG. 1 illustrates a seat leveling device 100 for stabilizing the seat of a vehicle when moving over uneven terrain. The seat leveling device 100 comprises a vehicle 102 and a seat 104 secured to the vehicle 102. The vehicle 102 is typically a hillside lift vehicle used to carry passengers and goods back and forth between a hilltop and a bottom of the hill. However, any other suitable vehicle can be used as is known in the art without affecting the overall concept of the invention, such as a tractor, a trolley, an all-terrain vehicle (ATV), etc.

The seat 104 is a typical vehicle seat as is known in the art, and can be any suitable size and shape depending on the wants and needs of a user and depending on the size and shape of the vehicle 102. Generally, the seat 104 is rectangular in shape, but can be any suitable shape as is known in the art without affecting the overall concept of the invention. Additionally, the seat 104 would generally be constructed of wood, aluminum, or plastic, such as polycarbonate, polyvinyl chloride (PVC), or acrylonitrile butadiene styrene (ABS), though any other suitable material may be used to manufacture the seat 104 as is known in the art without affecting the overall concept of the invention. The seat 104 is approximately between 24 and 60 inches long as measured from the first end 106 to the second end 108, approximately between 16 and 17 inches wide as measured from opposing sides 110, and approximately between 17 and 19 inches high. Specifically, the seat 104 is repositionable relative to the vehicle 102.

Furthermore, the second end 108 comprises a hinge which allows the first end 106 of the seat 104 to be raised or lowered during the leveling process. Specifically, the second end 108 of the seat can be secured via a piano hinge, a pin, a living hinge, etc., or any other suitable fastening means as is known in the art.

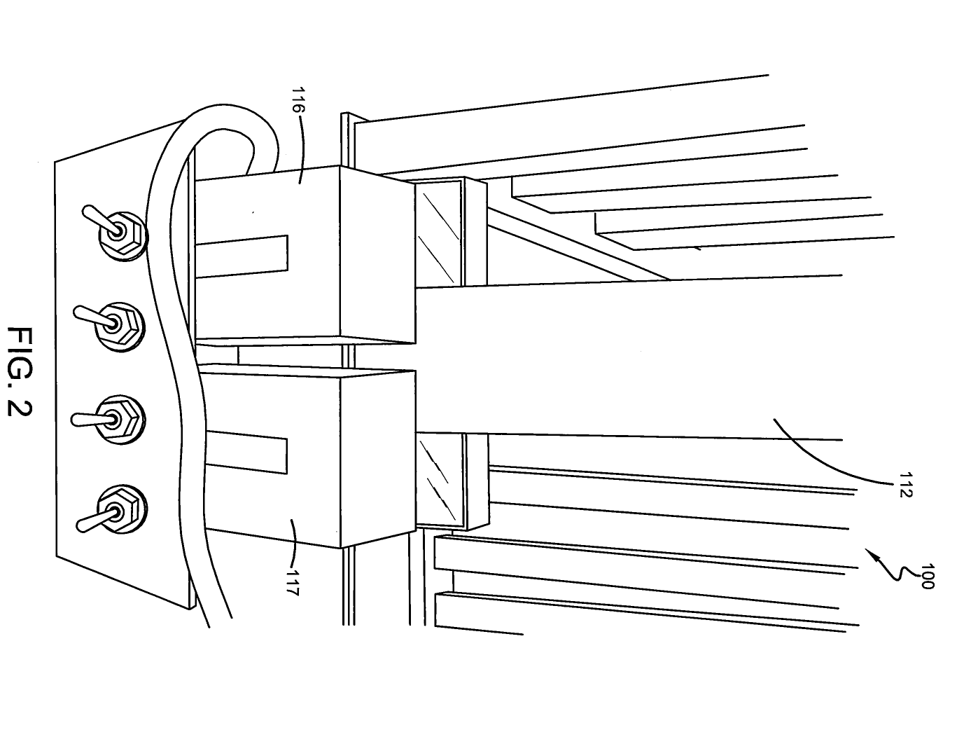

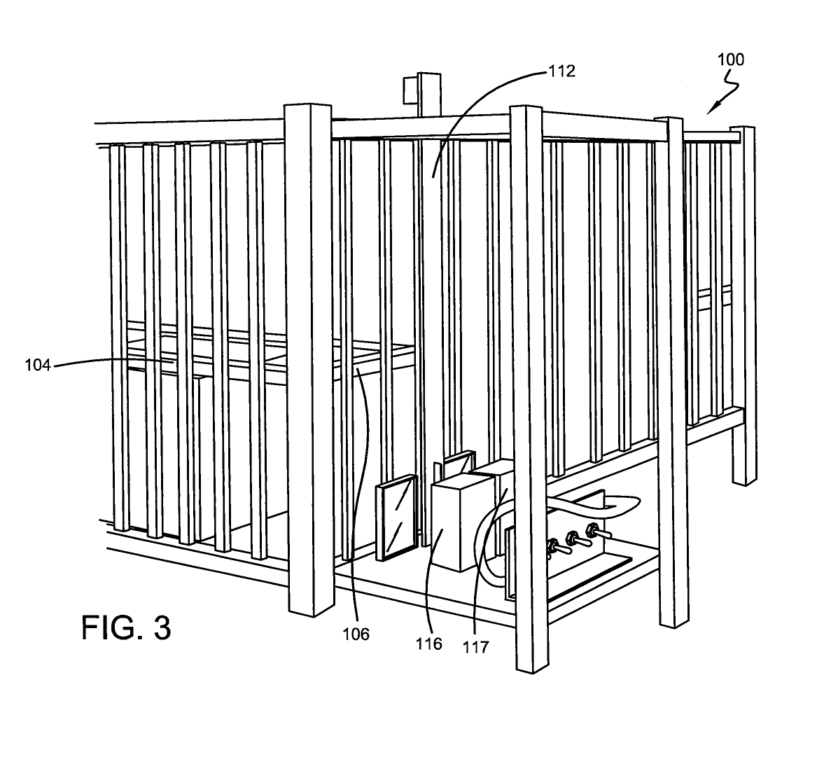

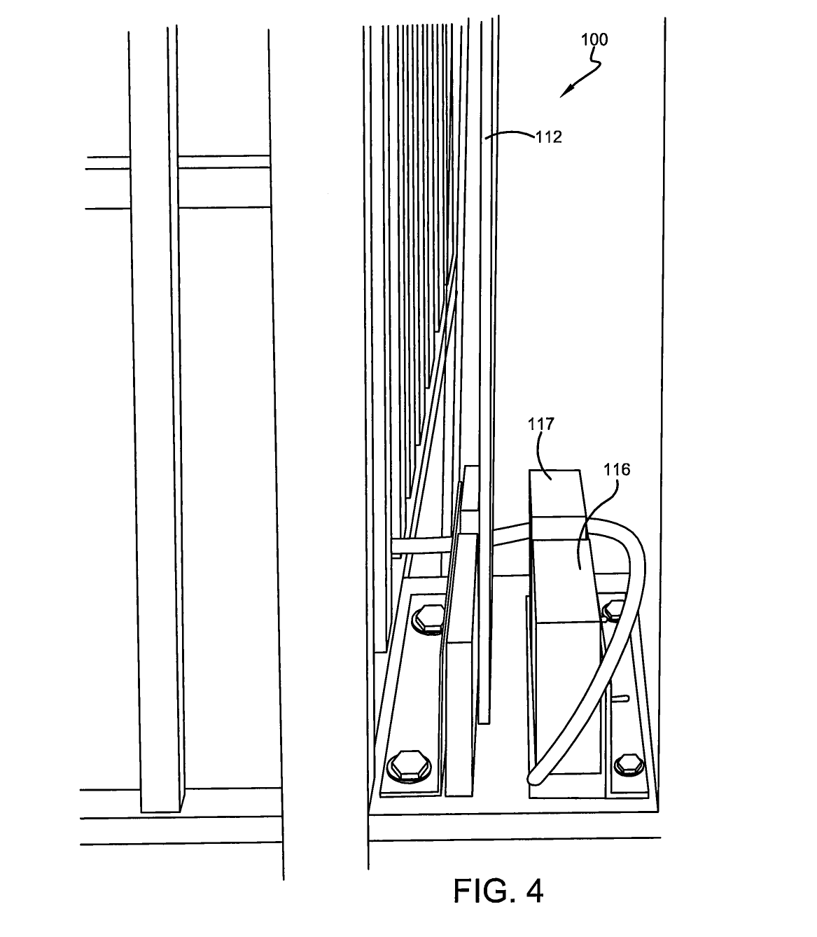

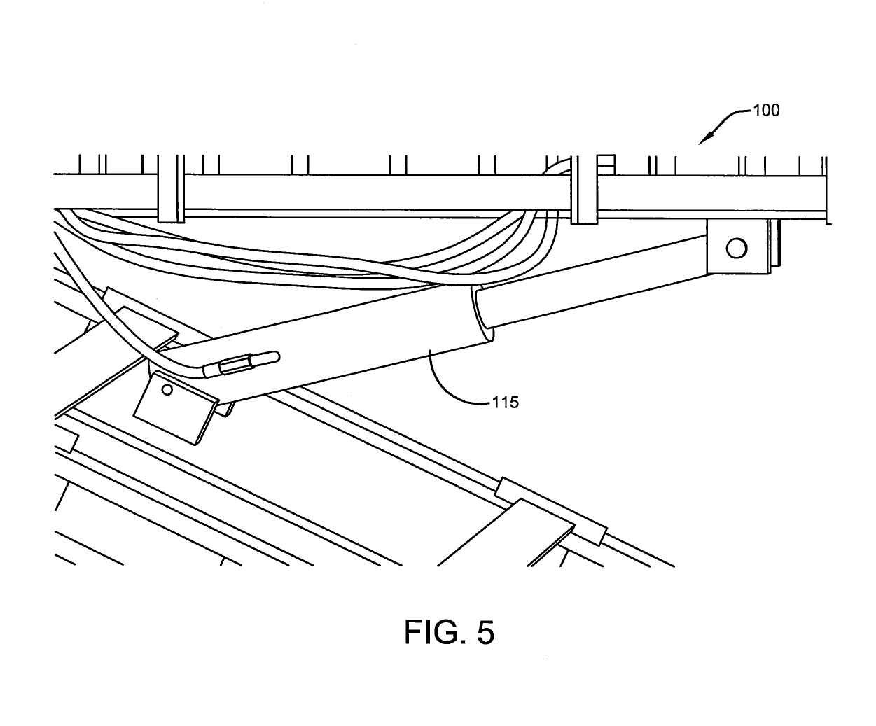

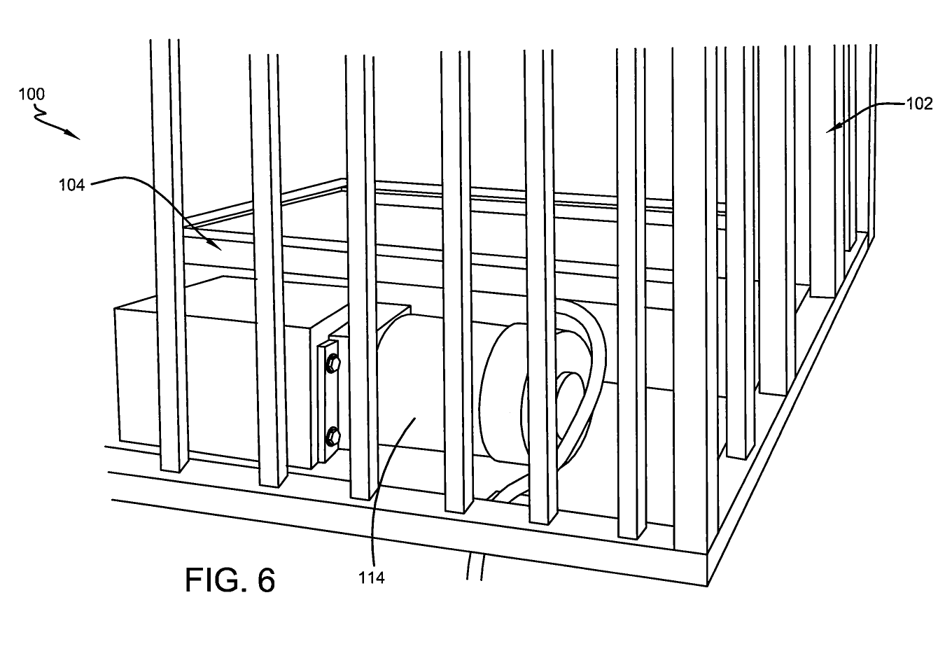

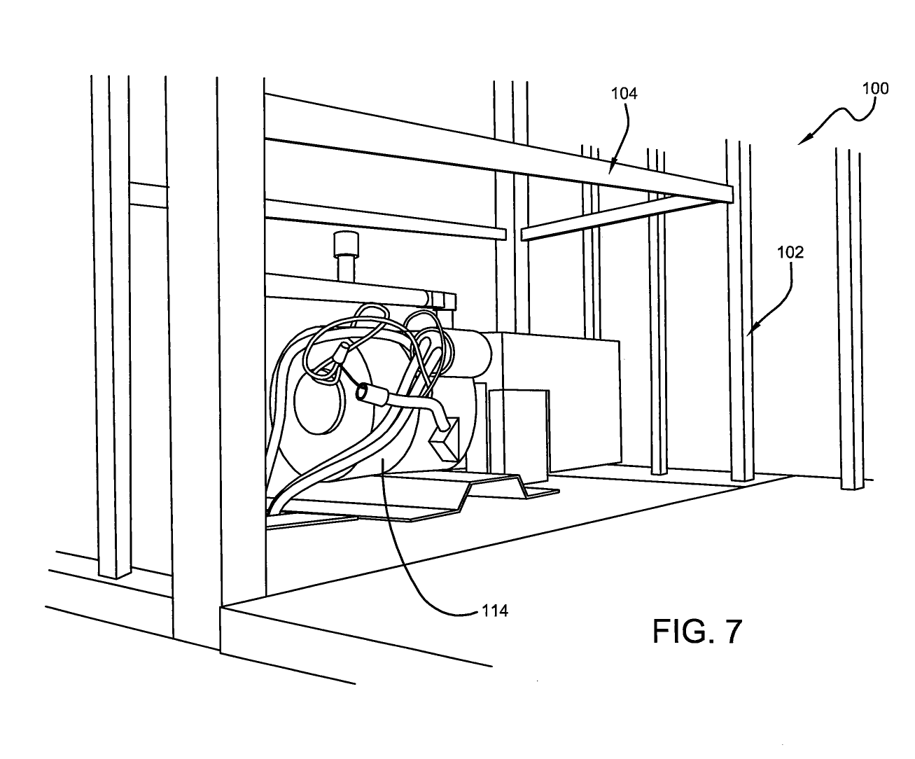

FIGS. 2-4 illustrate the detection component of the seat leveling device 100. Specifically, the seat leveling device 100 further comprises a detection component (shown as a pendulum 112) and a drive component (shown as a hydraulic pump 114 and cylinder 115 as shown in FIGS. 5-7), wherein the detection component is in communication with the drive component. Specifically, the detection component detects a position of the seat 104 and transmits a signal to the drive component when the seat 104 becomes unleveled. In one embodiment, the detection component is a pendulum 112. The pendulum 112 is secured to the seat 104, and swings when the seat 104 becomes unleveled. The pendulum 112 would be secured to the seat 104 via a pin, or any other suitable fastener as is known in the art without affecting the overall concept of the invention. The pendulum 112 would be secured to the back or bottom of the seat 104.

As the seat 104 becomes unleveled or changes planar angles, the pendulum 112 would swing. The natural swing of the pendulum 112 would cause the pendulum 112 to contact an activation switch (shown as photo cell switches 116 and 117). Typically, the pendulum 112 would swing approximately between 1 and 4 degrees in either direction before contacting an activation switch. Preferably, the pendulum 112 would swing approximately 2 degrees before contacting an activation switch. Thus, the seat 104 would go out of level about 2 degrees. However, seat movement of about 2 degrees would not be detectable by a passenger. Furthermore, the pendulum 112 movement depends on the length of the pendulum 112, the longer the pendulum 112, the more sensitive it will be. For example, at a length of 18 inches the pendulum 112 moves about a ½ inch before contacting an activation switch. Further, the seat 104 would only correct if the track angle were to change causing the pendulum 112 to contact an activation switch.

Contact with the activation switch causes the activation switch to close which activates the drive component to level the seat 104, (i.e., raise or lower the seat). The activation switch is typically a photo cell switch as is known in the art, but can be any other suitable switch as is known in the art, such as an electric switch. On an electric switch, contact by the pendulum 112 closes the circuit and activates the drive component. When photo cell switches are used, the forward photo cell switch 116 would activate the hydraulic pump 114 (or linear actuator) raising the front (or first end 106) of the seat 104 to level the seat 104, and the backward (or rear) photo cell switch 117 would open the return valve, collapsing the cylinder (or linear actuator), thus lowering the first end 106 of the seat 104 to make it level. The second end of the seat 104 remains on a hinge, allowing the raising and lowering of the first end 106 of the seat 104. The use of photo cell switches 116 and 117 allows a greater sensitivity to track changes. Using photo cell switches 116 and 117 causes the seat 104 to only tilt approximately about 2 degrees (which is not felt by the passengers), before contacting the drive component to level the seat 104. Furthermore, the photo cell switches 116 and 117 can be adjusted to allow the pendulum to swing more or less before activation of the drive component, depending on the needs and wants of a user. The photo cell switches 116 and 117 operate as photo cell switches known in the art, wherein the switches produce a beam of non-visible light which is then reflected by the return mirrors. The swing of the pendulum would interrupt the beam, triggering the drive component.

In another embodiment, the detection component is a pair of opposing mercury leveling switches (not shown) secured to the seat 104. The mercury leveling switches are typical mercury leveling switches as is known in the art, and would be secured to the seat 104 via hardware, or any other suitable fastener as is known in the art without affecting the overall concept of the invention. Typically, the mercury leveling switches would be secured to the back or bottom of the seat 104. As the seat 104 becomes unleveled or changes planar angles by approximately 2 degrees, the mercury within the leveling switches would shift to contact an activation switch (not shown) that is integral to the leveling switches. Contact with the activation switch causes the activation switch to close which activates the drive component to level the seat 104. The activation switch is typically an electric switch, but can be any other suitable switch as is known in the art. Contact by the mercury closes the circuit and activates the drive component. Additionally, the seat leveling device 100 can utilize any suitable leveler as is known in the art without affecting the overall concept of the invention.

FIGS. 5-7 illustrate the drive component of the seat leveling device 100. Furthermore, in one embodiment, the drive component comprises a hydraulic pump 114 and cylinder 115 as is known in the art. The hydraulic pump 114 and cylinder 115 act to level or reposition the seat 104 in response to movement of the detection component (i.e., the pendulum 112 as shown in FIGS. 2-4), such that the seat 104 remains relatively horizontal to the vehicle 102. Typically, contact with the activation switch causes the activation switch to close which activates the hydraulic pump 114 and cylinder 115 to level the seat 104. Specifically, when the forward photo cell switch (shown in FIGS. 2-4) is actuated the hydraulic pump 114 pumps hydraulic fluid into the cylinder 115, which raises the front (or first end) of the seat 104 to level the seat 104. And, when the backward (or rear) photo cell switch (shown in FIGS. 2-4) is actuated the return valve is opened, which allows hydraulic fluid out of the cylinder, collapsing the cylinder, and thus lowering the first end of the seat 104 to make it level.

Once the seat 104 moves back to a level position, the pendulum or mercury will move to a neutral position, and the seat 104 will remain in that position until the seat becomes unleveled or changes planar angles again. The neutral position is a position wherein the pendulum or mercury do not contact an activation switch or sensor, or interrupt a beam from the photo cell switch.

In another embodiment, the drive component comprises a linear actuator as is known in the art. The linear actuator acts to level or reposition the seat 104 in response to movement of the detection component (i.e., pendulum 112), such that the seat 104 remains relatively horizontal to the vehicle 102. Typically, contact with the activation switch (i.e., photo cell switch) causes the activation switch to close which activates the linear actuator to level or reposition the seat 104. Specifically, the forward photo cell switch (shown in FIGS. 2-4) would activate the linear actuator raising the front (or first end) of the seat 104 to level the seat 104, and the backward (or rear) photo cell switch (shown in FIGS. 2-4) would neutralize the linear actuator, thus lowering the first end of the seat 104 to make it level.

Once the seat 104 moves back to a level position, the pendulum or mercury will move to a neutral position, and the seat 104 will remain in that position until the seat becomes unleveled or changes planar angles again. The neutral position is a position wherein the pendulum or mercury do not contact an activation switch or sensor, or interrupt a beam from the photo cell switch. Additionally, the seat leveling device 100 can utilize any suitable drive mechanism as is known in the art without affecting the overall concept of the invention.

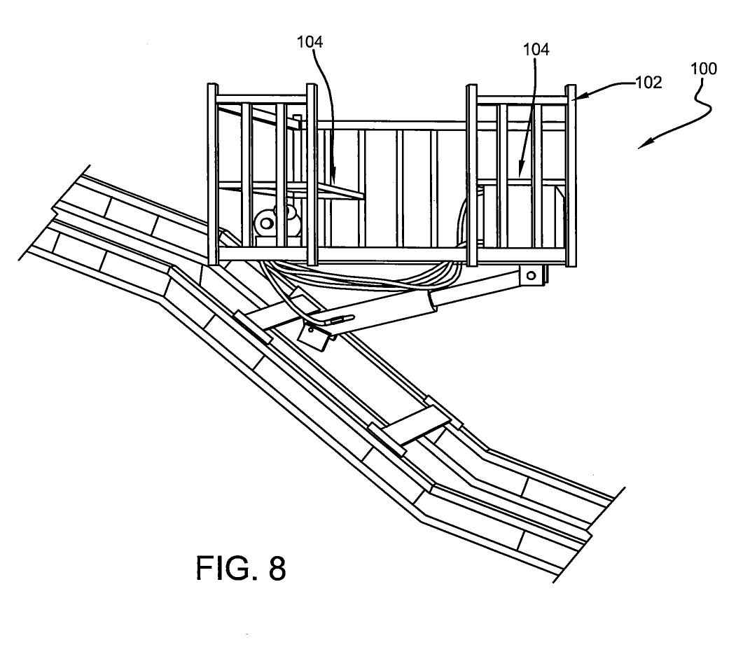

FIG. 8 illustrates the seat leveling device in use. In operation, a user would install or have the manufacturer install a seat leveling device 100 on the seat 104 of a hillside lift vehicle 102 or other suitable vehicle, which enables the seat 104 to be repositionable relative to the vehicle 102. The seat leveling device 100 comprises a detection component (i.e., a pendulum (shown in FIGS. 2-4)) secured to the back or bottom of the seat 104 and a drive component (i.e., a hydraulic pump 114 and cylinder 115 (shown in FIGS. 5-7)) in communication with the detection component. Once the detection component is secured to the seat 104, the detection component detects a position of the seat 104 and transmits a signal to the drive component when the seat 104 becomes unleveled. In this embodiment, the detection component is a pendulum. The pendulum is secured to the bottom of the seat 104 via a pin, and swings when the seat 104 becomes unleveled or changes planar angles.

Thus, along the course of a non-linear hillside lift track, the seat 104 becomes unleveled, which causes the pendulum to swing. The natural swing of the pendulum causes the pendulum to contact an activation switch. Typically, the pendulum would swing approximately 2 degrees in either direction before contacting an activation switch. Thus, the seat 104 would go out of level about 2 degrees. However, seat movement of about 2 degrees would not be detectable by a passenger. Contact with the activation switch causes the activation switch to close (or be interrupted) which activates the drive component to level or reposition (i.e., raise or lower) the seat 104, such that the seat 104 remains relatively horizontal to the vehicle 102.

In this embodiment, the drive component comprises a hydraulic pump and cylinder as is known in the art. Typically, contact with the activation switch (i.e. photo cell switches 116 and 117 (shown in FIGS. 2-4)) activates the hydraulic pump and cylinder to level or reposition the seat 104. Specifically, when the forward photo cell switch is actuated the hydraulic pump pumps hydraulic fluid into the cylinder, which raises the front (or first end) of the seat 104 to level the seat 104. And, when the backward (or rear) photo cell switch is actuated the return valve is opened, which allows hydraulic fluid out of the cylinder, collapsing the cylinder, and thus lowering the first end of the seat 104 to make it level. The seat 104 is hinged at the back or second end (uphill side) so the front (or first end) just raises and lowers to find level.

Once the seat 104 moves back to a level position, the pendulum moves to a neutral position, and the seat 104 will remain in that position until the seat 104 becomes unleveled or changes planar angles again. The neutral position is a position wherein the pendulum does not contact an activation switch or sensor, or interrupt a beam from the photo cell switch.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A seat leveling device for a vehicle comprising:
a vehicle;
a seat moveably secured to the vehicle;
a detection component that detects a position of the seat; and
a drive component in communication with the detection component, the drive component repositions the seat in response to the detection component; and
wherein the detection component transmits a signal to the drive component when the seat becomes unleveled.

2. The device of claim 1, wherein the detection component comprises a pendulum secured to the seat, the pendulum swings when the seat becomes unleveled.

3. The device of claim 2, wherein the drive component comprises a hydraulic pump and cylinder, the hydraulic pump and cylinder acts to raise or lower the seat in response to a signal from the pendulum.

4. The device of claim 3, further comprising an activation switch secured to the vehicle, the movement of the pendulum contacts the activation switch which activates the hydraulic pump and cylinder.

5. The device of claim 1, wherein the detection component comprises a pair of opposing mercury leveling switches secured to the seat, the mercury within the pair of leveling switches shifts to contact a sensor when the seat becomes unleveled.

6. The device of claim 5, wherein the drive component comprises a linear actuator, the linear actuator acts to raise or lower the seat in response to a signal from the pendulum.

7. The device of claim 6, further comprising an activation switch secured to the vehicle, the movement of the mercury contacts the sensor which closes the activation switch and activates the linear actuator.

8. The device of claim 1, wherein the vehicle is a hillside lift vehicle.

9. A seat leveling device for a vehicle comprising:
a vehicle;
a seat moveably secured to the vehicle;
a pendulum secured to the seat that detects a position of the seat relative to the vehicle; and
a drive component that repositions the seat in response to movement of the pendulum.

10. The device of claim 9, wherein the drive component comprises a hydraulic pump and cylinder, the hydraulic pump and cylinder act to raise or lower the seat in response to a signal from the pendulum.

11. The device of claim 10, further comprising a photo cell switch secured to the vehicle, the movement of the pendulum interrupts the photo cell switch which activates the hydraulic pump.

12. The device of claim 9, wherein the drive component comprises a linear actuator, the linear actuator acts to raise or lower the seat in response to a signal from the pendulum.

13. The device of claim 12, further comprising a photo cell switch secured to the vehicle, the movement of the pendulum interrupts the photo cell switch which activates the linear actuator.

14. The device of claim 9, wherein the vehicle is a hillside lift vehicle.

15. A seat leveling device for a vehicle comprising:
a vehicle;
a seat moveably secured to the vehicle;
a detection component that detects a position of the seat relative to the vehicle; and
a hydraulic pump and cylinder that raises or lowers the seat in response to a signal from the detection component.

16. The device of claim 15, wherein the detection component comprises a pendulum secured to the seat, the pendulum swings when the seat becomes unleveled.

17. The device of claim 16, further comprising a photo cell switch secured to the vehicle, the movement of the pendulum interrupts the photo cell switch which activates the hydraulic pump and cylinder.

18. The device of claim 15, wherein the detection component comprises a pair of opposing mercury leveling switches secured to the seat, the mercury within the pair of leveling switches shifts to contact a sensor when the seat becomes unleveled.

19. The device of claim 18, further comprising an activation switch secured to the vehicle, the movement of the mercury contacts the sensor which closes the activation switch and activates the hydraulic pump.

20. The device of claim 15, wherein the vehicle is a hillside lift vehicle.
